(19) United States
(12) Patent Application Publication
(10) Pub. No.: US 2026/0259334 A1
(43) Pub. Date: Sep. 3, 2026

(54) AN X-RAY MEASUREMENT SYSTEM AND A COOLING METHOD FOR COOLING A GE X-RAY DETECTOR

(71) Applicant: HEIKKI SIPILÄ OY, Espoo (FI)

(72) Inventor: Heikki Johannes Sipilä, Espoo (FI)

(21) Appl. No.: 18/875,284

(22) PCT Filed: Jun. 16, 2022
(86) PCT No.: PCT/FI2022/050421

§ 371 Date: Dec. 16, 2024

(51) Int. Cl. G01T 1/24

(52) U.S. Cl. CPC G01T 1/244

(57) ABSTRACT

An X-ray measurement system includes a Ge X-ray detector; a compressor radiator; and a thermal storage capsule arranged between the compressor radiator and the Ge X-ray detector. The thermal storage capsule has a housing and a phase change material arranged inside the housing; and a control system. The control system controls the compressor radiator to cool the thermal storage capsule and the Ge X-ray detector to a predefined cooling temperature. The PCM inside the housing of the thermal storage capsule freezes at the predefined cooling temperature. The control system turns off the cooling operation of the compressor radiator in response to detecting that the predefined cooling temperature is met and controls the Ge X-ray detector to perform X-ray measurement. The thermal storage capsule maintains the Ge X-ray detector at a constant predefined cooling temperature during X-ray measurement. A cooling method is for cooling a Ge X-ray detector.

### CROSS-REFERENCE TO RELATED APPLICATIONS

This application is a National Stage Application of PCT/FI2022/050421, filed Jun. 16, 2022, which application is incorporated herein by reference. To the extent appropriate, a claim of priority is made to the above-disclosed application.

### TECHNICAL FIELD

The invention concerns in general the technical field of X-ray measurements. Especially the invention concerns cooling solutions of X-ray measurements with Ge X-ray detectors.

### BACKGROUND

Germanium (Ge) X-ray detectors may be used in various X-ray measurement applications. Ge X-ray detectors may for example be used for K X-ray fluorescence analyzers, where the efficiency of Silicon (Si) detectors is too low. The energy range what is suitable for the Ge X-ray detectors is from 20 keV to 120 keV. However, the Ge X-ray detectors needs to be cooled to an operation temperature of the Ge X-ray detectors (e.g. minimum to 120 K), otherwise too large leakage currents may disturb the X-ray measurements. Typically, the Ge X-ray detectors are cooled by using liquid nitrogen-based cooling solutions. However, the liquid nitrogen-based cooling solutions are not very practical for cooling the Ge X-ray detectors. Another option is to use a compressor radiator for cooling the Ge X-ray detectors. By using the compressor radiator, the operation temperature of the Ge X-ray detectors (or even lower temperatures) can easily be achieved and at least some of the drawbacks of the liquid nitrogen-based cooling solutions may be mitigated. However, during the cooling operation the compressor radiator is vibrating which causes microphonism. The microphonism, in turn, causes additional noise in the X-ray measurements with the Ge X-ray detector because of the very low-level signals used in the X-ray measurements with the Ge X-ray detector. Typically, in the X-ray measurements with the Ge X-ray detector the signals are substantially at a level of kilo-electronvolts (keV). The energy range of the Ge X-ray detectors may begin even from 0.1 keV. This means that the X-ray measurements with the Ge X-ray detectors will be at least disturbed or possibly even ruined because of the microphonism. Therefore, the elimination of the microphonism is required in the X-ray measurements with the Ge X-ray detector, especially at the signal levels below 20 keV. For example, as a comparison in X-ray measurements with gamma detectors the signals are at a level of above 100 keV up to MeV. Thus, the compressor radiator does not cause any notable additional noise in the X-ray measurements with gamma detectors.

Therefore, there is a need to develop further cooling solutions for X-ray measurements with Ge X-ray detectors.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an X-ray measurement system and a cooling method for cooling a Ge X-ray detector. Another objective of the invention is that the X-ray measurement system and the cooling method for cooling a Ge X-ray detector enables eliminating microphonism in a cooling solution for Ge X-ray detectors.

The objectives of the invention are reached by an X-ray measurement system and a cooling method as defined by the respective independent claims.

According to a first aspect, an X-ray measurement system is provided, wherein the X-ray measurement system comprises: a Ge X-ray detector for performing an X-ray measurement; a compressor radiator; a thermal storage capsule arranged between the compressor radiator and the Ge X-ray detector, wherein the thermal storage capsule comprises a housing and a phase change material (PCM) arranged inside the housing; and a control system configured to: control the compressor radiator to cool the thermal storage capsule and the Ge X-ray detector to a predefined cooling temperature, wherein the PCM inside the housing of the thermal storage capsule freezes at the predefined cooling temperature; turn off the cooling operation of the compressor radiator in response to detecting that the predefined cooling temperature is met; and control the Ge X-ray detector to perform the X-ray measurement; wherein the thermal storage capsule maintains the temperature of the Ge X-ray detector constant at the predefined cooling temperature during the X-ray measurement.

The PCM may depend on the predefined cooling temperature.

The thermal storage capsule may further comprise copper foam arranged inside the thermal storage capsule.

The duration of the X-ray measurement may be between 10 seconds to 10 minutes.

The predefined cooling temperature may be between 85 K and 120 K depending on the PCM.

The thermal storage capsule may further comprise a temperature sensor configured to measure the temperature inside the thermal storage capsule.

The Ge X-ray detector and the thermal storage capsule may be enclosed in a vacuum chamber

According to a second aspect, a cooling method for cooling a Ge X-ray detector is provided, wherein the method comprises: controlling a compressor radiator to cool a thermal storage capsule and the Ge X-ray detector to a predefined cooling temperature, the thermal storage capsule is arranged between the compressor radiator and the Ge X-ray detector, wherein a phase change material (PCM) arranged inside a housing of the thermal storage capsule freezes at the predefined cooling temperature; turning off the cooling operation of the compressor radiator in response to detecting that the predefined cooling temperature is met; and controlling the Ge X-ray detector to perform an X-ray measurement, wherein the thermal storage capsule maintains the temperature of the Ge X-ray detector constant at the predefined cooling temperature during the X-ray measurement.

The PCM may depend on the predefined cooling temperature.

The thermal storage capsule may further comprise copper foam arranged inside the thermal storage capsule.

The duration of the X-ray measurement may be between 10 seconds to 10 minutes.

The predefined cooling temperature may be between 85 K and 120 K depending on the PCM.

The cooling method may further comprise measuring with a temperature sensor the temperature inside the thermal storage capsule.

The Ge X-ray detector and the thermal storage capsule may be enclosed in a vacuum chamber.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an X-ray measurement system.

FIGS. 2A and 2B illustrate schematically examples of a thermal storage capsule.

FIG. 3 illustrates schematically an example of a method for cooling a Ge X-ray detector.

FIG. 4 illustrates schematically an example of a temperature inside a thermal storage capsule as function of time.

FIG. 5 illustrates schematically an example of components of a control system.

### DESCRIPTION OF THE EXEMPLIFYING EMBODIMENTS

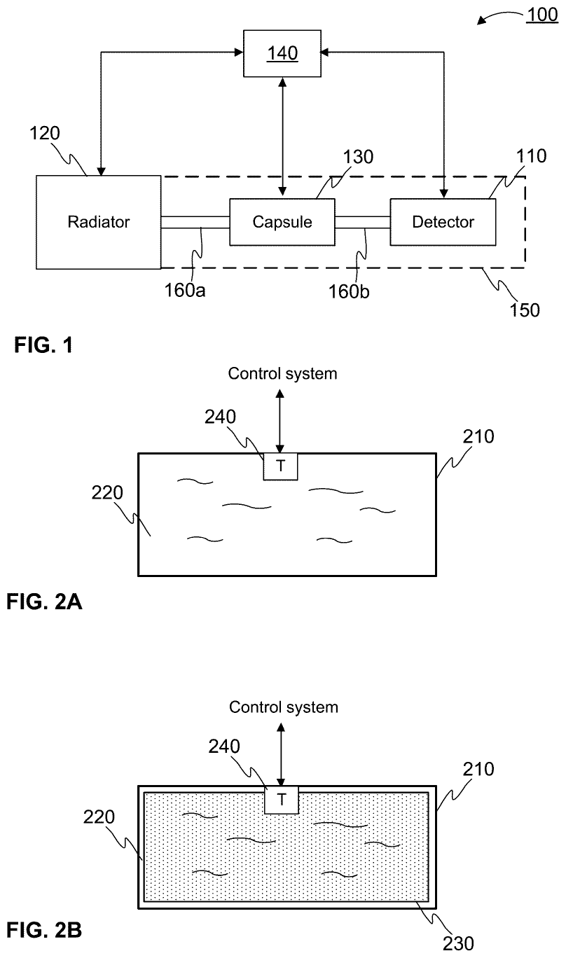

FIG. 1 illustrates schematically an example of an X-ray measurement system 100. The X-ray measurement system 100 comprises a germanium (Ge) X-ray detector 110, a compressor radiator 120, a thermal storage capsule 130, and a control system 140. The Ge X-ray detector 110 may be used for performing X-ray measurements, for example, but not limited to, K X-ray fluorescence measurements. The Ge X-ray detector 110 and the thermal storage capsule 130 may be enclosed in a vacuum chamber 150. The control system 140 is communicatively coupled to Ge X-ray detector 110 and the compressor radiator 120, wherein the communication may be based on one or more known communication technologies, either wired or wireless. The control system 140 may be configured to control the operations of the X-ray measurement system 100 at least in part.

The thermal storage capsule 130 is arranged between the compressor radiator 120 and the Ge X-ray detector 110. The thermal storage capsule 130 may be connected via heat pipes 160a, 160b to the compressor radiator 120 and to the Ge X-ray detector 110. The thermal storage capsule 130 comprises a housing 210 and a phase change material PCM 220 arranged inside the housing 210. The phase change materials are materials that are able to absorb, store, and release heat during phase transition, i.e. when the material changes its state. FIG. 2A illustrates schematically a simple example of the thermal storage capsule 130. In the example of FIG. 2A the PCM 220 is in a liquid state inside the thermal storage capsule 130. Every PCM has its characteristic freezing temperature, i.e. a PCM temperature. The PCM 220 arranged inside the thermal storage capsule 130 may be selected based on a desired cooling temperature for the Ge X-ray detector 110. The desired cooling temperature for the Ge X-ray detector 110 may for example be between 85 K and 120 K. The PCM 220 arranged inside the thermal storage capsule 130 may then be any PCM having the freezing temperature between 85 K and 120 K. Examples of different PCMs and their freezing temperatures are introduced in a publication F. Edelstein “The behavior of cryogenic phase change materials used for IR sensor thermal control in space” SAE Technical Paper 911555, 1991. According to a non-limiting example, the PCM 220 may for example be, but is not limited to, propane. The freezing temperature of the propane is 85 K. According to another non-limiting example, the PCM 220 may for example be, but is not limited to, 2-Methylpentane. The freezing temperature of the 2-Methylpentane is 119 K. The material of the housing 210 may preferably be a material that has a good thermal conductivity. A non-limiting example for the material of the housing 210 may e.g. be copper. According to an example, the thermal storage capsule 130 may further comprise a temperature sensor 240 configured to measure the temperature inside the thermal storage capsule 130 as illustrated in the example of FIG. 2A. The temperature sensor 240 may provide the measured temperature to the control system 140. The temperature sensor 240 may be communicatively coupled to the control system 140. The communication between the control system 140 and the temperature sensor 240 may be based on one or more known communication technologies, either wired or wireless.

The thermal storage capsule 130 may further comprise copper foam 230 arranged inside the thermal storage capsule 130. The copper foam 230 is a porous material with a good thermal conductivity. The copper foam 230 may be arranged inside the thermal storage capsule 130 substantially evenly. Alternatively or in addition, the copper foam 230 may for example be arranged inside the thermal storage capsule 130 so that the copper foam 230 takes up less than 10% of the volume of the thermal storage capsule 130. The copper foam 230 arranged inside the thermal storage capsule 130 enables good internal thermal conductivity inside the thermal storage capsule 130, which in turn enables that the temperature of the PCM 220 inside the thermal storage capsule 130 is constant and that the PCM 220 freezes and melts steadily. Furthermore, the copper foam 230 is low-cost material. FIG. 2B illustrates schematically an example of the thermal storage capsule 130 further comprising the copper foam 230 arranged inside the thermal storage capsule 130. In the example of FIG. 2B the PCM 220 is in the liquid state inside the thermal storage capsule 130.

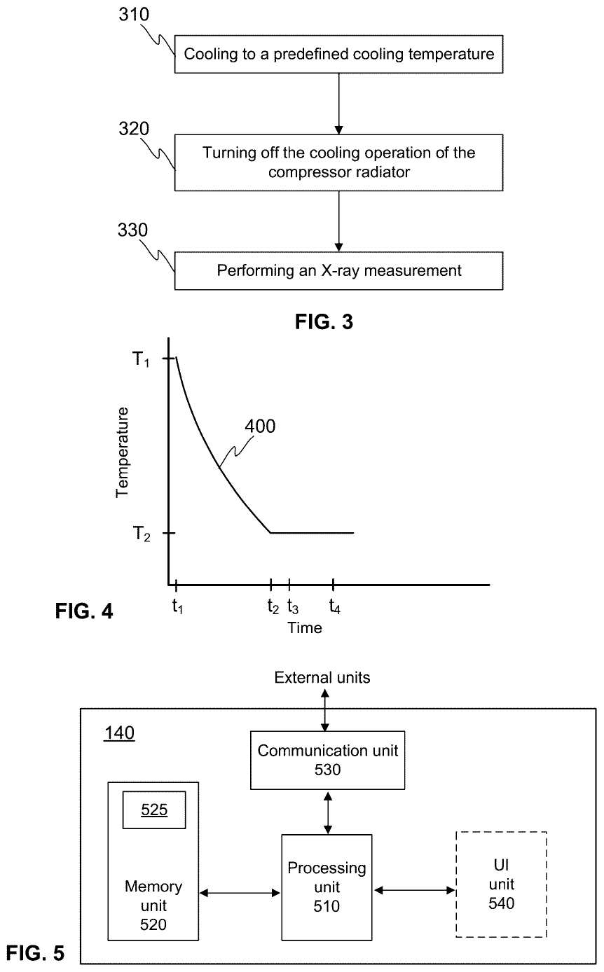

Next an example of a method for cooling the Ge X-ray detector 110 is described by referring to FIG. 3. FIG. 3 schematically illustrates the method as a flow chart.

At a step 310, the control system 140 controls the compressor radiator 120 to cool the thermal storage capsule 130 and the Ge X-ray detector 110 to a predefined cooling temperature. In other words, the control system 140 controls the compressor radiator 120 to start a cooling operation for cooling the thermal storage capsule 130 and the Ge X-ray detector 110 to the predefined cooling temperature. The PCM 220 arranged inside the housing 210 of the thermal storage capsule 130 freezes at the predefined cooling temperature, i.e. changes its state from liquid to solid. Because of the good thermal conductivity capability of the thermal storage capsule 130 also the Ge X-ray detector 110 is cooled substantially to the predefined cooling temperature, when the compressor radiator 120 cools the thermal storage capsule 130 to the predefined cooling temperature. The predefined cooling temperature may for example be between 85 K and 120 K depending on the PCM 220 arranged inside the thermal storage capsule 130. As discussed above, the PCM 220 arranged inside the thermal storage capsule 130 may be selected based on the desired cooling temperature. The predefined cooling temperature may correspond to the desired cooling temperature. Thus, the PCM 220 arranged inside the thermal storage capsule 130 may be selected based on the predefined cooling temperature. In other words, the PCM 220 arranged inside the thermal storage capsule 130 may depend on the predefined cooling temperature. For example, if the predefined cooling temperature is between 85 K and 120 K, the PCM 220 arrange inside the thermal storage capsule 130 may be any PCM having the freezing temperature between 85 K and 120 K. According to a non-limiting example, if the predefined cooling temperature is 85 K, the PCM 220 arranged inside the thermal storage capsule 130 may for example be propane, because the freezing temperature of the propane is 85 K. According to another non-limiting example, if the predefined cooling temperature is 119 K, the PCM 220 arranged inside the thermal storage capsule 130 may for example be 2-Methylpentane, because the freezing temperature of the 2-Methylpentane is 119 K. The control system 140 may monitor the temperature inside the thermal storage capsule 130 by obtaining the temperature measured by the temperature sensor 240.

At a step 320, in response to detecting that the predefined cooling temperature is met, the control system 140 turns off the cooling operation of the compressor radiator 120. In other words, the control system 140 detects that the temperature inside the thermal storage capsule 130 reaches the predefined cooling temperature and/or that the temperature inside the thermal storage capsule 130 is less than the predefined cooling temperature. The cooling operation of the compressor radiator 120 is turned off during an X-ray measurement performed by the Ge X-ray detector 110, because the vibration of the compressor radiator 120 would cause microphonism, which, in turn, would cause additional noise in the X-ray measurements with the Ge X-ray detector 110. Thus, turning off the cooling operation of the compressor radiator 120 during the X-ray measurement eliminates the microphonism in the compressor radiator 120 and thus decreases the noise in the X-ray measurements.

At a step 330, after turning off the cooling operation of the compressor radiator 120, the control system 140 controls the Ge X-ray detector 110 to perform the X-ray measurement. The thermal storage capsule 130 maintains the temperature of the Ge X-ray detector 110 constant at the predefined cooling temperature during the X-ray measurement. As the temperature of the PCM 220 arranged inside the housing 210 of the thermal storage capsule 130 remains constant at the predefined cooling temperature during the X-ray measurement, it causes that the thermal storage capsule 130 maintains the temperature of the Ge X-ray detector 110 constant at the cooling predefined temperature during the X-ray measurement. After turning off the cooling operation of the compressor radiator 120, the PCM 220 inside the housing 210 of the thermal storage capsule 130 starts to melt and the temperature of the PCM 220 remains constant at the predefined cooling temperature as long as there exists at least some PCM in the solid state inside the thermal storage capsule 130. Therefore, to maintain the temperature inside the thermal storage capsule 130 constant at the predefined cooling temperature during the X-ray measurement, the duration of the X-ray measurement should be less than the time required for melting the PCM 220 entirely. For example, the duration of the X-ray measurement may be between 10 seconds to 10 minutes.

After performing the X-ray measurement by the Ge X-ray detector 110, the control system 140 may control the compressor radiator 120 to continue the cooling of the thermal storage capsule 130 and the Ge X-ray detector 110. In other words, the control system 140 may control the compressor radiator 120 to restart the cooling operation for cooling the thermal storage capsule 130 and the Ge X-ray detector 110.

FIG. 4 illustrates schematically an example of the temperature 400 inside the thermal storage capsule 130 as function of time. At a time instant t₁, the control system 140 controls the compressor radiator 120 start the cooling operation. At the time instant t₁, the temperature 400 inside the thermal storage capsule 130 may for example be at an ambient temperature T₁. At a time instant t₂, the control system 140 detects that the predefined cooling temperature T₂ is met (i.e. the PCM 220 is frozen at the predefined cooling temperature T₂) and the control system 140 turns off the cooling operation of the compressor radiator 120. After turning off the cooling operation of the compressor radiator 120, the temperature 400 of the PCM 220 inside the housing 210 of the thermal storage capsule 130 maintains at the predefined cooling temperature T₂ until melting of the PCM 220 entirely and/or until restarting the cooling operation of the compressor radiator 120 (for sake of clarity not shown in FIG. 4). At a time instant t₃, the control system 140 controls the Ge X-ray detector 110 to start the X-ray measurement. At a time instant t₄, the control system 140 controls the Ge X-ray detector 110 to stop the X-ray measurement. The thermal storage capsule 130 maintains the temperature of the Ge X-ray detector 110 constant at the predefined cooling temperature T₂ during the X-ray measurement, i.e. the time between the time instants t₃ and t₄.

FIG. 5 illustrates schematically an example of components of the control system 140. The control system 140 may comprise a processing unit 510 comprising one or more processors, a memory unit 520 comprising one or more memories, a communication unit 530 comprising one or more communication devices, and possibly a user interface (UI) unit 540. The mentioned elements may be communicatively coupled to each other with e.g. an internal bus. The memory unit 520 may store and maintain portions of a computer program (code) 525, the measured temperature inside the thermal storage capsule 130, and any other data. The computer program 525 may comprise instructions which, when the computer program 525 is executed by the processing unit 510 of the control system 140 may cause the processing unit 510, and thus the control system 140 to carry out desired tasks, e.g. one or more of the method steps described above. The processing unit 510 may thus be arranged to access the memory unit 520 and retrieve and store any information therefrom and thereto. For sake of clarity, the processor herein refers to any unit suitable for processing information and control the operation of the control system 140, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication unit 530 provides one or more communication interfaces for communication with any other unit, e.g. the compressor radiator 120, the Ge X-ray detector 110, the temperature sensor 240, one or more databases, and/or with any other unit. The user interface unit 540 may comprise one or more input/output (I/O) devices, such as buttons, keyboard, touch screen, microphone, loudspeaker, display and so on, for receiving user input and outputting information. The computer program 525 may be a computer program product that may be comprised in a tangible nonvolatile (non-transitory) computer-readable medium bearing the computer program code 525 embodied therein for use with a computer, i.e. the control system 140. Some non-limiting examples of the control system 140 may e.g. be a personal computer, a laptop computer, a tablet computer, a server, a computing circuit, a network of computing devices.

The specific examples provided in the description given above should not be construed as limiting the applicability and/or the interpretation of the appended claims. Lists and groups of examples provided in the description given above are not exhaustive unless otherwise explicitly stated.

1. An X-ray measurement system comprising:
a Ge X-ray detector for performing an X-ray measurement;
a compressor radiator;
a thermal storage capsule arranged between the compressor radiator and the Ge X-ray detector wherein the thermal storage capsule comprises a housing and a phase change material arranged inside the housing; and
a control system configured to:
control the compressor radiator to cool the thermal storage capsule and the Ge X-ray detector to a predefined cooling temperature, wherein the PCM inside the housing of the thermal storage capsule freezes at the predefined cooling temperature;
turn off cooling of the compressor radiator in response to detecting that the predefined cooling temperature is met; and
control the Ge X-ray detector to perform the X-ray measurement;
wherein the thermal storage capsule maintains the temperature of the Ge X-ray detector constant at the predefined cooling temperature during the X-ray measurement.

2. The X-ray measurement system according to claim 1, wherein the PCM depends on the predefined cooling temperature.

3. The X-ray measurement system according to claim 1, wherein the thermal storage capsule further comprises copper foam arranged inside the thermal storage capsule.

4. The X-ray measurement system according to claim 1, wherein a duration of the X-ray measurement is between 10 seconds and 10 minutes.

5. The X-ray measurement system according to claim 1, wherein the predefined cooling temperature is between 85 K and 120 K depending on the PCM.

6. The X-ray measurement system according to claim 1, wherein the thermal storage capsule further comprises a temperature sensor configured to measure temperature inside the thermal storage capsule.

7. The X-ray measurement system according to claim 1, wherein the Ge X-ray detector and the thermal storage capsule are enclosed in a vacuum chamber.

8. A cooling method for cooling a Ge X-ray detector, the method comprises:
controlling a compressor radiator to cool a thermal storage capsule and the Ge X-ray detector to a predefined cooling temperature, the thermal storage capsule is arranged between the compressor radiator and the Ge X-ray detector, wherein a phase change material arranged inside a housing of the thermal storage capsule freezes at the predefined cooling temperature;
turning off the cooling of the compressor radiator in response to detecting that the predefined cooling temperature is met; and
controlling the Ge X-ray detector to perform an X-ray measurement, wherein the thermal storage capsule maintains a temperature of the Ge X-ray detector constant at the predefined cooling temperature during the X-ray measurement.

9. The cooling method according to claim 8, wherein the PCM depends on the predefined cooling temperature.

10. The cooling method according to claim 8, wherein the thermal storage capsule further comprises copper foam arranged inside the thermal storage capsule.

11. The cooling method according to claim 8, wherein a duration of the X-ray measurement is between 10 seconds and 10 minutes.

12. The cooling method according to claim 8, wherein the predefined cooling temperature is between 85 K and 120 K depending on the PCM.

13. The cooling method according to claim 8, further comprising measuring with a temperature sensor the temperature inside the thermal storage capsule.

14. The cooling method according to claim 8, wherein the Ge X-ray detector and the thermal storage capsule are enclosed in a vacuum chamber.
